(19) United States
(12) Patent Application Publication
(10) Pub. No.: US 2015/0144502 A1
(43) Pub. Date: May 28, 2015

(54) ELECTROCHEMICALLY-ASSISTED MEGASONIC CLEANING SYSTEMS AND METHODS

(71) Applicant: The Arizona Board of Regents on Behalf of the University of Arizona, Tucson, AZ (US)

(72) Inventors: Manish K. Keswani, Tucson, AZ (US); Pierre A. Deymier, Tucson, AZ (US); Srini Raghavan, Tucson, AZ (US)

(21) Appl. No.: 14/554,279

(22) Filed: Nov. 26, 2014

Related U.S. Application Data
(60) Provisional application No. 61/909,978, filed on Nov. 27, 2013.

(51) Int. Cl. C25F 1/00; B08B 3/08; B08B 3/12

(52) U.S. Cl. CPC C25F 1/00; B08B 3/12; B08B 3/08
USPC 205/687; 204/232

(57) ABSTRACT

An electrochemically-assisted megasonic cleaning method includes applying an electrical potential to a conductive surface immersed in solution to form bubbles of gaseous molecules produced by electrochemical reaction, and applying a megasonic field to the solution to oscillate the bubbles and clean the conductive surface without causing damage. An electrochemically-assisted megasonic cleaning system includes an electrical supply for applying electrical potential to a conductive surface immersed in solution to induce bubble formation in the solution and at the surface through an electrochemical reaction, and a transducer for applying a megasonic field to the solution to induce oscillation of the bubbles.

### CROSS-REFERENCE TO RELATED APPLICATIONS

This invention claims priority to U.S. Provisional Patent Application Ser. No. 61/909,978, filed on Nov. 27, 2013, which is incorporated by reference herein in its entirety.

### U.S. GOVERNMENT RIGHTS

This invention was made with government support under Grant No. ECCS0925340 awarded by National Science Foundation. The government has certain rights in the invention.

### BACKGROUND

Acoustic fields are commonly used to clean the surface of an object. The surface is placed in a solution and an acoustic field is applied to the solution. The acoustic field induces formation of bubbles from gaseous molecules in the solution. Bubbles will undergo oscillatory motion such as contraction and expansion in response to the acoustic field. This motion may lead to growth of the bubbles through a mechanism known as rectified diffusion. Frequently, bubbles collapse, which produces a shock wave propagating through the solution. Such shock waves are particularly effective at dislodging contaminants from a surface.

Ultrasonic and megasonic cleaning are two acoustic-based cleaning methods. In ultrasonic cleaning, the acoustic field typically has a frequency in the range from 20 kilohertz (kHz) to 200 kHz. Megasonic cleaning, on the other hand, uses an acoustic field with a frequency in the range from about 0.8 megahertz (MHz) to 2 MHz. Bubbles exposed to the lower frequencies of ultrasonic cleaning typically oscillate with the acoustic field for a few cycles before collapsing. These collapsing bubbles are known as transient cavities. Bubbles exposed to the higher frequencies associated with megasonic cleaning are more likely to undergo stable cavitation. While oscillating, the bubbles induce movement of the solution, which may dislodge contaminants from a surface. Since the forces associated with such movement are weaker than the forces associated with collapse induced shock waves, megasonic cleaning is gentler than ultrasonic cleaning. This is beneficial in scenarios where the surface to be cleaned is easily damaged. For example, small features on a surface may not have the strength to withstand the forces associated with the frequent and strong shock waves of ultrasonic cleaning. Hence, surfaces with small or fragile features are preferably cleaned using megasonic cleaning.

However, even the lower collapse rate associated with megasonic cleaning has proven too violent for some applications. As microfabrication methods have advanced to allow production of smaller features, often as small as 20 nanometers (nm), the need for a gentler yet effective alternative to conventional megasonic cleaning has become apparent.

### SUMMARY

In an embodiment, an electrochemically-assisted megasonic cleaning method includes applying an electrical potential to a conductive surface immersed in a solution to form bubbles of gaseous molecules produced by electrochemical reaction, and applying a megasonic field to the solution to oscillate the bubbles and clean the conductive surface.

In an embodiment, an electrochemically-assisted megasonic cleaning system includes an electrical supply for applying electrical potential to a conductive surface immersed in solution to induce bubble formation in the solution and at the surface through an electrochemical reaction, and a transducer for applying a megasonic field to the solution to induce oscillation of the bubbles.

### BRIEF DESCRIPTION OF THE DRAWINGS

FIG. 1 illustrates an electrochemically-assisted megasonic cleaning system, according to an embodiment.

FIG. 2 illustrates an electrochemically-assisted megasonic cleaning method, according to an embodiment.

FIG. 3 shows schematics illustrating processes associated with the method of FIG. 2, according to an embodiment.

FIG. 4 illustrates a method for performing a portion of the method of FIG. 2, according to an embodiment.

FIG. 5 illustrates embodiments of objects that may be cleaned using the systems of FIGS. 1 and 6 using the methods of FIGS. 2 and 7.

FIG. 6 illustrates an electrochemically-assisted megasonic cleaning system configured for monitoring solution movement and optional active feedback, according to an embodiment.

FIG. 7 illustrates an electrochemically-assisted megasonic cleaning method that includes monitoring solution movement and optional active feedback, according to an embodiment.

FIG. 8 shows microscope images of a Tantalum surface before intentional contamination, after intentional contamination, and after cleaning using the system of FIG. 1 and the method of FIG. 2.

FIG. 9 shows results of an experiment to investigate aspects of the method of FIG. 2 performed using the system of FIG. 6.

FIG. 10 shows results of an experiment wherein a Tantalum surface is cleaned using the system of FIG. 1 according the method of FIG. 2.

FIG. 11 shows results of an experiment wherein a Tantalum surface is cleaned using the system of FIG. 1 according to the method of FIG. 2.

FIG. 12 shows chronoamperometry measurements on a Platinum microelectrode immersed in an aqueous solution, generated using the system of FIG. 6 according to the method of FIG. 7, with the megasonic field operated at 100% duty cycle.

FIG. 13 shows chronoamperometry measurements on a Platinum microelectrode immersed in an aqueous solution, generated using the system of FIG. 6 according to the method of FIG. 7, with the megasonic field operated at 10% duty cycle and 5 ms pulse time.

FIG. 14 shows the effect of megasonic transducer duty cycle (for fixed duty cycle of 5 ms) on chronoamperometry measurements conducted on a Platinum microelectrode immersed in an argon saturated aqueous solution including a probe species, generated using the system of FIG. 6 according to the method of FIG. 7.

FIG. 15 shows portions of the data of FIG. 14 on an expanded time scale.

FIG. 16 shows the effect of megasonic transducer duty cycle (for fixed duty cycle of 5 ms) on chronoamperometry measurements conducted on a Platinum microelectrode immersed in a carbon dioxide saturated aqueous solution including a probe species, generated using an embodiment of the system of FIG. 6 according to an embodiment of the method of FIG. 7.

FIG. 17 shows portions of the data of FIG. 16 on an expanded time scale.

### DETAILED DESCRIPTION OF THE EMBODIMENTS

Disclosed herein are systems and methods for electrochemically-assisted megasonic cleaning of surfaces that include a conductive portion. The systems and methods may be applied to purely conductive surfaces for cleaning of the conductive surface. The systems and methods may also be applied to surfaces that include a combination of non-conductive and conductive surface portions, for cleaning of the conductive surface portions as well as nearby non-conductive surface portions. The power density of the megasonic field is reduced as compared to that of conventional megasonic cleaning, which significantly reduces the probability of bubbles forming or collapsing in the solution away from the conductive surface. To compensate for this reduction, an electrochemical reaction is induced on a conductive portion of the surface. The reaction produces gaseous molecules at the conductive surface, which in turn results in a relatively high concentration of bubbles at the conductive surface.

The low-power megasonic field is optimized to induce oscillatory motion of the bubbles without promoting transient cavitation. The megasonic field is operated at a duty cycle, defined as the ratio of an on-time to the total time of a pulse of the megasonic field, with the on-time chosen to control the size of the bubbles. Bubbles extending significantly beyond the acoustic boundary layer at the surface are likely to be swept away by streaming flow in the solution. The acoustic boundary layer is a layer extending a distance (ν/ω)^{0.5} from the surface into the solution, where the ν is the kinematic viscosity of the solution and ω is the frequency of the acoustic (megasonic) field. Within the acoustic boundary layer, flow is attenuated due to a stationary boundary condition at the surface. Outside the acoustic boundary layer, flow is unimpeded by the surface. Hence, in the streaming flow beyond the acoustic boundary layer, the bubbles are subject to greater forces and are more likely to collapse. It is therefore advantageous to avoid bubbles entering the streaming flow. The off-time of the megasonic field is set to allow for the majority of bubbles formed during the on-time to dissolve, which reduces the probability of a bubble growing over several on-times. Accordingly, bubble growth is controlled to result in a very low probability of bubbles transforming to transient cavities.

During the on-time, bubbles at the surface oscillate in size in response to the acoustic field. When the pressure of the acoustic field, at the location of a bubble, is high, the bubble is compressed. Conversely, when the pressure of the acoustic field is low, the bubble undergoes rarefaction. The necessary response of the surrounding fluid to the cyclic compression and rarefaction of bubbles is termed microstreaming. Micro streaming is capable of dislodging contaminants from the surface without exposing the surface to the strong forces associated with bubble collapse.

The present electrochemically-assisted megasonic cleaning systems and methods have utility in a variety of application. In general, these systems and methods are useful for cleaning of surfaces too fragile to withstand the forces of conventional megasonic cleaning. Particular examples include, but are not limited to, cleaning of semiconductor devices, photovoltaic devices, magnetic storage devices, liquid crystal displays, and plasma displays.

In certain embodiments, the power density of the megasonic field, at the acoustic boundary layer, is in the range 0.01 Watts per square centimeter (W/cm²) to 2 W/cm². Power densities below this range may be insufficient for cleaning, while power densities above this range have the potential to damage the surface being cleaned. In one embodiment, the power density of the megasonic field, at the acoustic boundary layer, is in less than 0.7 W/cm².

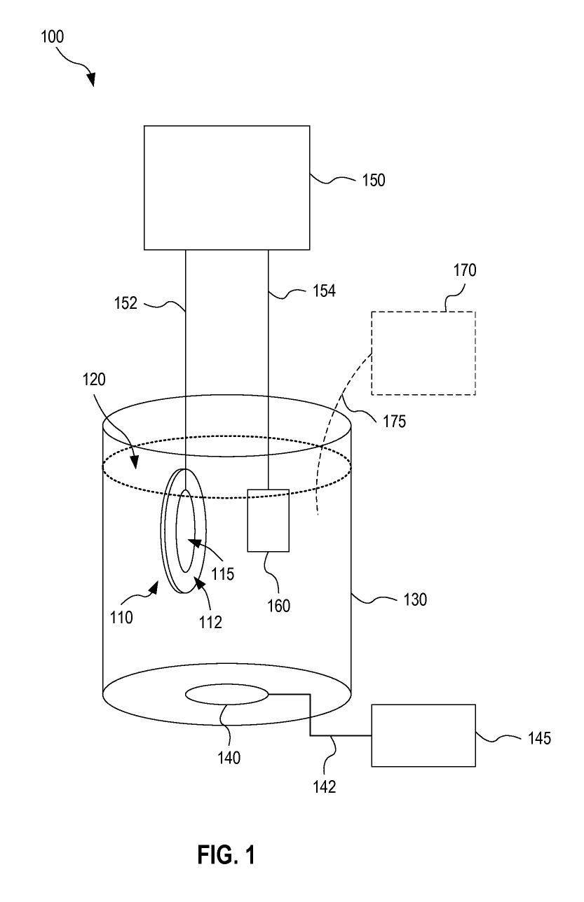

FIG. 1 illustrates one exemplary system 100 for electrochemically-assisted megasonic cleaning of the surface of an object 110 with a surface 112 that includes a conductive portion 115. System 100 includes a container 130 for holding a solution 120, and a megasonic transducer 140 for applying a megasonic field to solution 120. Megasonic transducer 140 is communicatively coupled through connector 142 to a controller 145, which controls the operation of megasonic transducer. System 100 further includes an electrical supply 150 for applying a potential to conductive portion 115 relative to the potential of reference electrode 160 in contact with solution 120. Electrical supply 150 is electrically coupled to conductive portion 115 through connection 152, and to reference electrode 160 through connection 154. In certain embodiments (not illustrated in FIG. 1), a conductive portion of surface 112, different from conductive portion 115, functions as reference electrode 160.

Optionally, system 100 includes a bubbling system 170 that is coupled (175) with solution 120. Optional bubbling system 170 bubbles a gas through solution 120 to optimize the concentration of a specific type of dissolved gas or to remove undesirable gasses therefrom. In an alternative embodiment, system 170 is a vacuum pump for degasing the solution. Solution degasing may reduce the risk of bubbles forming in the solution outside the acoustic boundary layer associated with surface 112. Thus solution degasing may reduce the risk of the bubble collapse associated with transient cavitation.

Conductive portion 115 may include one or more of doped silicon; graphene, single layer h-BN (boron nitride), metals such as copper, aluminum, chromium, tantalum, tungsten, titanium, ruthenium, molybdenum, and silver; metal oxides; doped metal oxides such as indium tin oxide, aluminum doped zinc oxide and indium doped zinc oxide; metal nitrides such as tantalum nitride and titanium nitride; and conductive polymers.

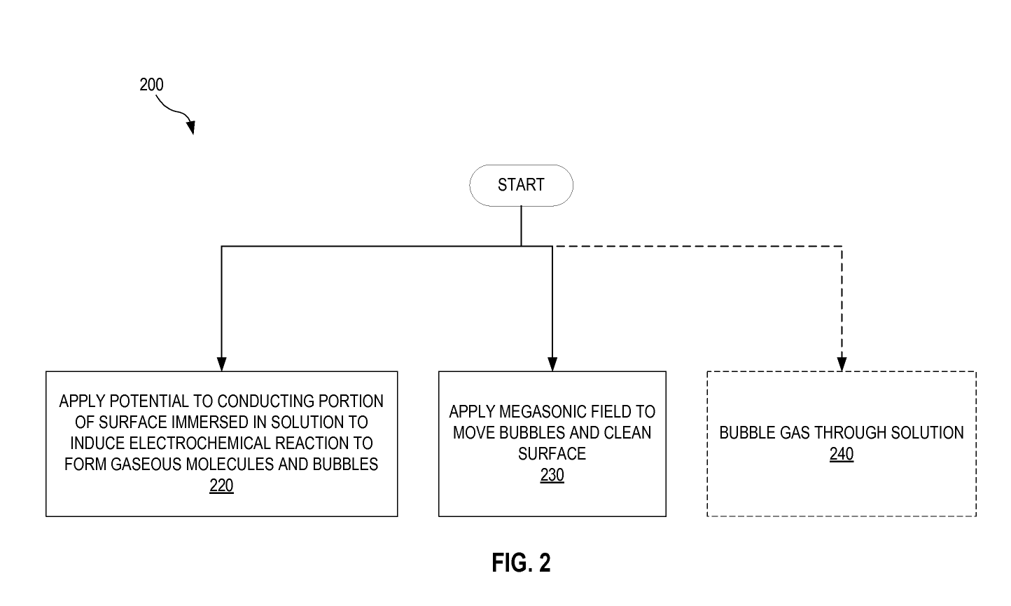

FIG. 2 illustrates one exemplary method 200 for electrochemically-assisted cleaning of a surface that includes a conductive portion. Method 200 is performed, for example, by system 100 of FIG. 1. Method 200 executes steps 220, 230, and optionally 240, in parallel.

In a step 220, an electrical potential is applied to the conductive portion of a surface immersed in a solution, where the electrical potential is defined relative to a reference potential applied to an electrode in contact with the solution, such that an electrochemical reaction is induced at the conductive portion of the surface. The conductive portion of the surface may be considered a working electrode. In the electrochemical reaction, a portion of the solution reacts to form a gaseous molecule. The gaseous molecules may nucleate and form bubbles.

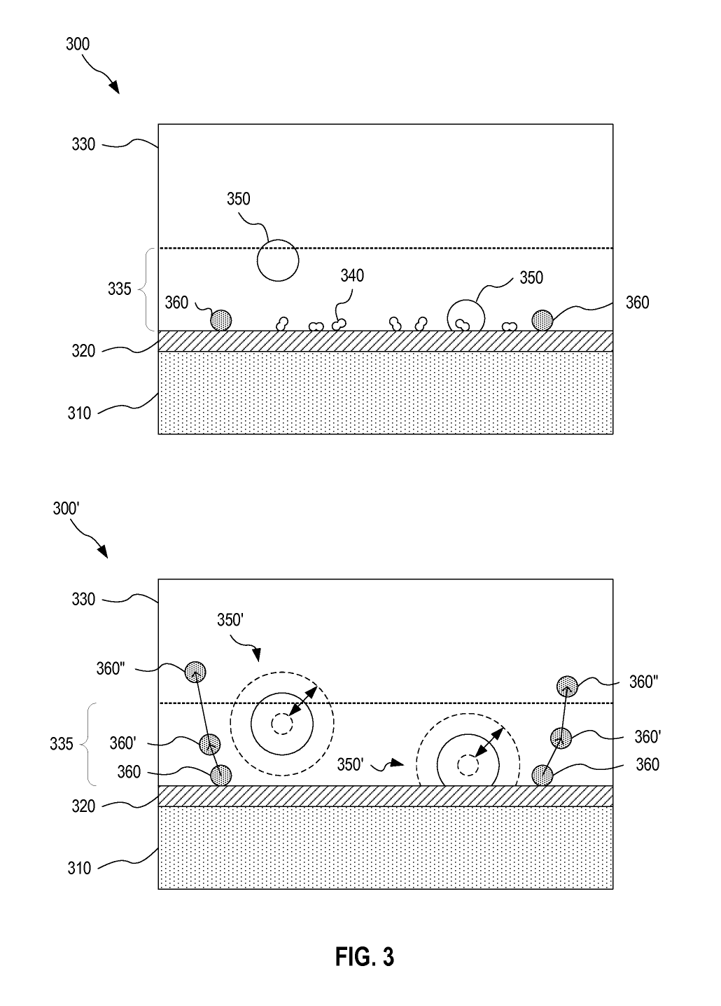

Step 220 is illustrated in FIG. 3 in an exemplary schematic 300. An object 310 has a conductive surface portion 320 and contaminants 360 located thereon. Conductive surface portion 320 is in contact with a solution 330. During step 220, electrochemical reactions at conductive surface portion 320 produce gaseous molecules 340 (only one labeled in FIG. 3) at conductive surface portion 320. Gaseous molecules 340 may nucleate to form bubbles 350 in solution 330. Schematic 300 further indicates the acoustic boundary layer 335. Bubbles 350 may be in contact with conductive surface portion 320 or away from conductive surface portion 320. Bubbles 350 may further be located within acoustic boundary layer 335, or extend beyond acoustic boundary layer 335.

In an embodiment, the electrochemical reaction is a reduction reaction, in which a solution molecule is reduced to a gaseous molecule. In a particular embodiment, the solution is an aqueous solution. The electrical potential applied to the conductive portion of the surface, relative to the reference electrical potential, is more negative than the reduction potential of water. Thus, a water molecule may undergo reduction to form a dihydrogen (H₂) molecule and two hydroxyl anions at the conductive portion of the surface. For example, electrical supply 150 (FIG. 1) applies an electrical potential difference between conductive portion 115 (FIG. 1) and reference electrode 160 (FIG. 1), both immersed in solution 120 (FIG. 1). In this example, solution 120 (FIG. 1) is an aqueous solution. The electrical potential difference between conductive portion 115 (FIG. 1) and reference electrode 160 (FIG. 1) is such that the electrical potential of conductive portion 115 (FIG. 1), relative to that of reference electrode 160 (FIG. 1) is less than the reduction potential of water. Reduction reactions at conductive portion 115 (FIG. 1) produce H₂ molecules. Some of the H₂ molecules form bubbles in solution 120 (FIG. 1).

In step 230, a megasonic field is applied to the solution. For example, controller 145 (FIG. 1) controls megasonic transducer 140 (FIG. 1) to apply a megasonic field to solution 120 (FIG. 1). Bubbles generated in step 220 respond to the megasonic field by oscillating in size. The bubble oscillation induces microstreaming in the surrounding fluid. The micro streaming generates forces on contaminants on the surface, which may be sufficient to dislodge the contaminants from the surface. Further, the bubble oscillation induced by the megasonic field may cause the bubbles to grow by rectified diffusion of additional gaseous molecules, formed in step 220, into the bubbles. In an embodiment, the megasonic field is applied for an amount of time sufficient to grow the bubbles to a size that is resonant with the megasonic field. This leads to strong microstreaming and, hence, greater and/or more sustained forces on contaminants. The frequency of the megasonic field may be further set such that the resonant bubble size is smaller than the minimum feature sizes of the surface. The resonant bubble size decreases with increasing megasonic frequency. Hence, narrow features such as trenches and vias may be cleaned using a high megasonic frequency.

The combined effect of steps 220 and 230 is illustrated in FIG. 3 in an exemplary schematic 300′. Schematic 300′ is a time-evolved situation of the situation illustrated in schematic 300, where schematic 300′ illustrates a combined effect of steps 220 and 230. As bubbles 350′ oscillate in size, microstreaming forces dislodge contaminants 360 from conductive surface portion 320 and move these to the streaming flow outside acoustic boundary layer 335. This movement is illustrated by the evolution of contaminants 360 located at conductive surface portion 320, to contaminants 360′ located away from conductive surface portion 320 within acoustic boundary layer 335, to contaminants 360″ located in the streaming flow outside acoustic boundary layer 335.

Optionally, method 200 includes a step 240, wherein a gas is bubbled through the solution to remove undesirable gases therefrom. Step 240 may be performed by gas flow module/bubbling system 170 (FIG. 1), which bubbles a gas (e.g., an inert gas) through solution 120 (FIG. 1) to remove undesirable gases therefrom. The gas bubbled through the system is for example an inert gas. Step 240 is beneficial, for example, in situations where the object to be cleaned is sensitive to such gases. The presence of oxygen in the solution may modify the surface properties of the object. For example, a pure silicon surface is semiconducting. However, a silicon surface allowed to react with oxygen may transform to silicon dioxide, which is an electrical insulator. In certain embodiments, step 240 is initiated prior to step 210 to remove reactive gasses from the solution prior to immersing the object in the solution. Step 240 may also be applied to add a gas to the solution for reducing the risk of bubble collapse. For example, the addition of carbon dioxide (CO₂) to an aqueous solution may reduce the risk of transient cavitation. In an embodiment, step 240 is initiated prior to steps 220 and 230 such that the solution is properly conditioned prior to performing step 220 and 230.

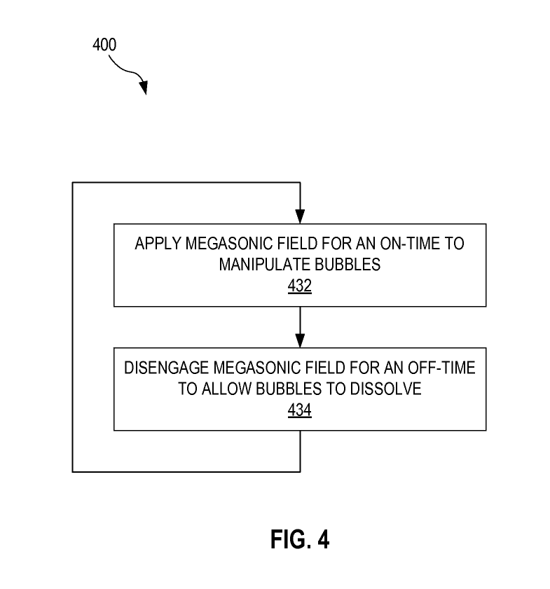

FIG. 4 illustrates one exemplary method 400 for performing step 230 of method 200 (FIG. 2). Method 400 operates the megasonic field at a duty cycle defined by an on-time and an off-time. In a step 432, the megasonic field is applied for an on-time, during which the megasonic field manipulates bubbles to clean the surface of the object. Step 432 is performed, for example, by controller 145 (FIG. 1) by engaging megasonic transducer 140 (FIG. 1) for a duration matching the on-time at a certain power. In an embodiment, the on-time is selected to maximize the cleaning effect of microstreaming due to bubble oscillation, while minimizing the number of bubbles moving or growing into the streaming flow outside the acoustic boundary layer or transforming into transient bubbles. This minimizes the risk of bubble collapse and associated damage to the surface of the object. The effect of the megasonic field during step 432 is a function not only of the on-time but also of, for example, the frequency and power density of the megasonic field, the kinematic viscosity of the solution, and the concentration of gaseous molecules, formed in step 220 (FIG. 2), present in the solution. In an embodiment, step 432 is performed with on-time, power density, kinematic viscosity, and gaseous molecule concentration that maximizes the cleaning effect from microstreaming is maximized while minimizing the risk of bubble collapse. For example, on-time, power density, and frequency of the megasonic field are selected to maintain a majority of bubbles within the acoustic boundary layer.

In an embodiment, the on-time is in the range from 0.1 milliseconds (ms) to 100 ms, or less than 10 ms. In another embodiment, the power density of the megasonic field at the acoustic boundary layer, i.e., at the interface between the acoustic boundary layer and the region of streaming flow, is 0.01 W/cm² to 2 W/cm², or less than 0.7 W/cm². In a further embodiment, the frequency is in the range from 0.5 Megahertz (MHz) to 100 MHz. In yet another embodiment, the viscosity is that of water, or approximately that of water.

In a step 434, the megasonic field is disengaged for an off-time to allow bubbles formed during the performance of step 432 to dissolve. This reduces the risk of bubbles growing to a size extending sufficiently far beyond the acoustic boundary layer for the bubbles to be swept into the streaming flow. Accordingly, the risk of bubbles collapsing is reduced. Step 432 is performed, for example, by controller 145 (FIG. 1) by disengaging megasonic transducer 140 (FIG. 1) for a duration matching the off-time.

In an embodiment of method 400, the megasonic field is operated at a duty cycle in the range from 1% to 50%. In another embodiment, the megasonic field is operated at a duty cycle less than 20%.

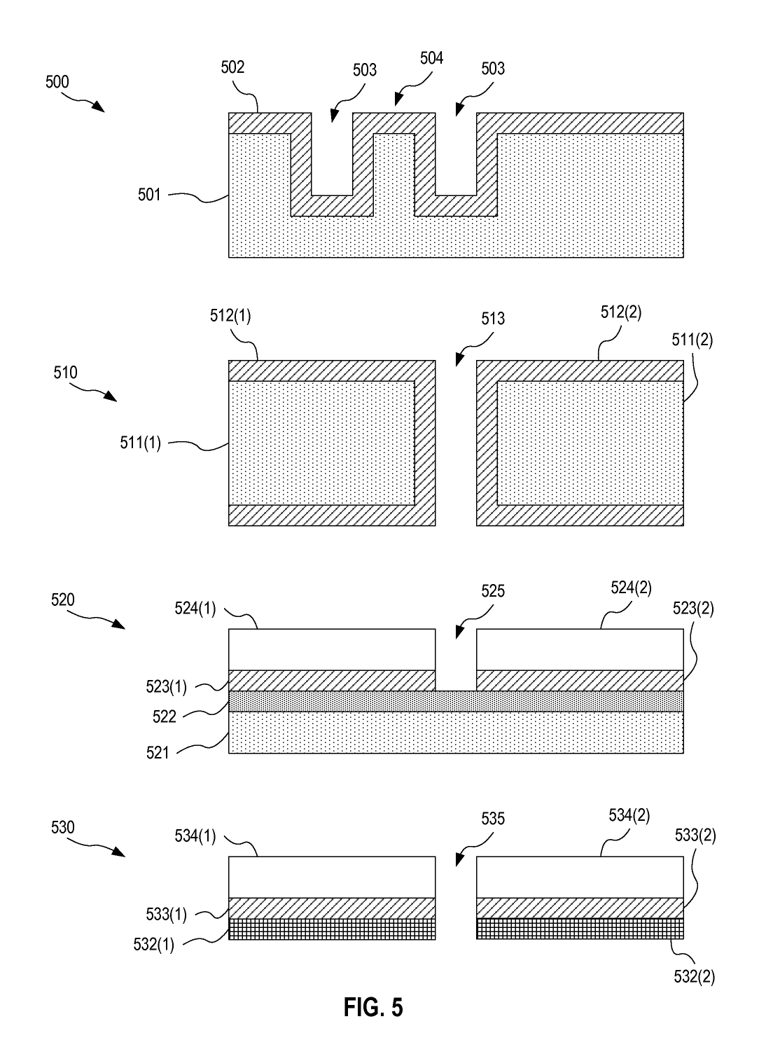

FIG. 5 illustrates exemplary embodiments 500, 510, 520, and 530 of object 110 of FIG. 1 in cross sectional view. Object 500 includes a substrate 501 with a conductive surface portion 502, which is an embodiment of conductive portion 115 (FIG. 1). Conductive surface portion 502 forms trenches 503 separated by a wall 504. In certain embodiments, trenches 503 and wall 504 are tall and narrow, and wall 504 is susceptible to damage when cleaned using conventional megasonic cleaning. For example, the depths of trenches 503 are in the range from 100 nanometers (nm) to 1000 nm, and the widths of trenches 503 and wall 504 are in the range from 5 nm to 500 nm.

Object 510 includes substrates 511(1) and 511(2), and respective conductive surface portions 512(1) and 512(2). Conductive surface portions 512(1) and 512(2) form a via 513. In one embodiment, conductive surface portions 512(1) and 512(2) are not electrically connected. One of conductive surface portions 512(1) and 512(2) is an embodiment of conductive portion 115 (FIG. 1). Optionally, the other one of conductive surface portions 512(1) and 512(2) is an embodiment of reference electrode 160 (FIG. 1). In another embodiment, conductive surface portions 512(1) and 512(2) are electrically connected (not shown in FIG. 5). For example, the cross-sectional view of object 510 may illustrate a via in a wafer. In this embodiment, conductive surface portions 512(1) and 512(2) together constitute an embodiment of conductive portion 115 (FIG. 1). In certain embodiments, via 513 is tall and narrow, for example with a depth in the range from 100 nanometers (nm) to 1000 nm and a width in the range from 5 nm to 500 nm.

Object 520 is a multilayer object including a substrate 521, a dielectric 522, conductive portions 523(1) and 523(2), and dielectric portions 524(1) and 524(2). Conductive portion 523(1) and dielectric portion 524(1) are separated, at least locally, from conductive portion 523(2) and dielectric portion 524(2) by a trench 525. In one embodiment, conductive portions 523(1) and 523(2) are not electrically connected. One of conductive portions 523(1) and 523(2) is an embodiment of conductive portion 115 (FIG. 1). Optionally, the other one of conductive portions 523(1) and 523(2) is an embodiment of reference electrode 160 (FIG. 1). In another embodiment, conductive portions 523(1) and 523(2) are electrically connected (not shown in FIG. 5). For example, the cross-sectional view of object 520 may illustrate a trench of finite length in a wafer. In this embodiment, conductive portions 523(1) and 523(2) together constitute an embodiment of conductive portion 115 (FIG. 1). In certain embodiments, trench 525 is tall and narrow, for example with a depth in the range from 100 nanometers (nm) to 1000 nm and a width in the range from 5 nm to 500 nm.

Object 530 is a multilayer object including semiconductors 532(1) and 532(2), conductive portions 533(1) and 533(2), and dielectrics 534(1) and 534(2). Semiconductor 532(1), conductive portion 533(1), and dielectric 534(1) are separated, at least locally, from semiconductor 532(2), conductive portion 533(2), and dielectric 534(2) by a gap 535. Gap 535 may be a via or a trench. In one embodiment, conductive portions 533(1) and 533(2) are not electrically connected. One of conductive portions 533(1) and 533(2) is an embodiment of conductive portion 115 (FIG. 1). Optionally, the other one of conductive portions 533(1) and 533(2) is an embodiment of reference electrode 160 (FIG. 1). In another embodiment, conductive portions 533(1) and 533(2) are electrically connected (not shown in FIG. 5). For example, the cross-sectional view of object 530 may illustrate a via in a wafer. In this embodiment, conductive portions 533(1) and 533(2) together constitute an embodiment of conductive portion 115 (FIG. 1). In certain embodiments, gap 535 is tall and narrow, for example with a depth in the range from 100 nanometers (nm) to 1000 nm and a width in the range from 5 nm to 500 nm.

All of objects 500, 510, 520 and 530 may be cleaned according to method 200 (FIG. 2) using, for example, system 100 (FIG. 1). The properties of the megasonic field may be adjusted to facilitate resonant bubble oscillation (oscillation that is resonant with the megasonic field) within the features 503, 513, 525, and 535, without causing intolerable surface damage. Further, the gaseous molecules generated at conductive surface portions may lead to the formation of bubbles that enable cleaning of nearby non-conductive surface portions. For example, the gaseous molecules formed at conductive surface portions 533(1) and 533(2) may lead to the formation of bubbles with sufficient size, oscillation, and movement to clean the surfaces of semiconductor 532(1) and 532(2), and dielectrics 534(1) and 534(2) inside gap 535.

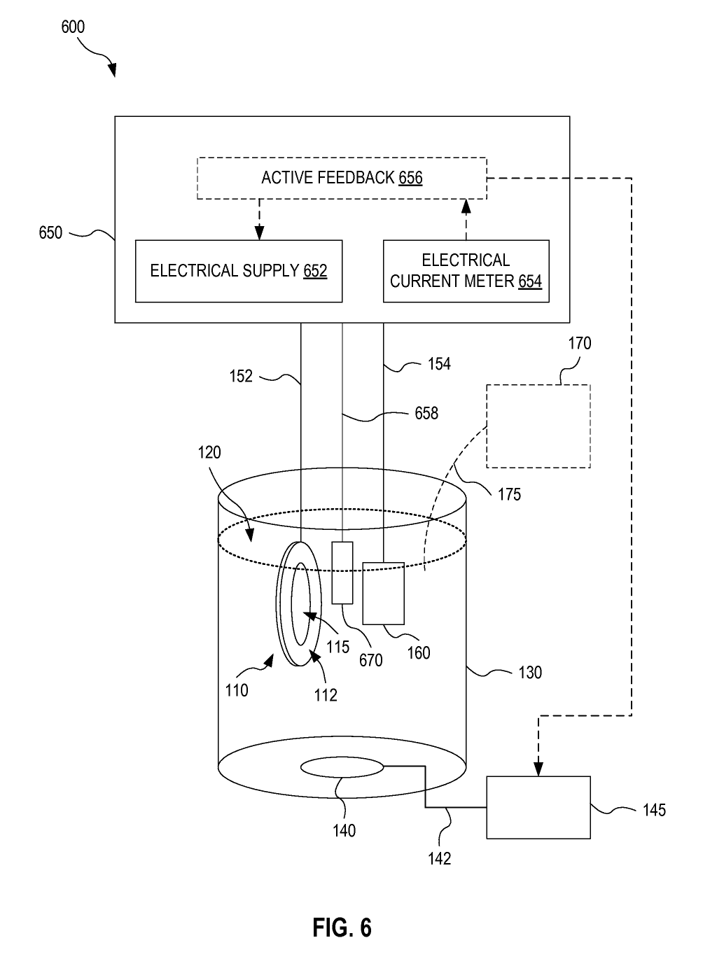

FIG. 6 illustrates one exemplary system 600 for electrochemically-assisted megasonic cleaning for cleaning of a surface that includes a conductive portion. System 600 includes sensoring capability. System 600 is an extension of system 100 of FIG. 1. In comparison to system 100, system 600 includes an additional electrode, counter electrode 670, and electrical supply 150 is replaced by an electrical system 650. Electrical system 650 includes an electrical supply 652, an electrical current meter 654, and, optionally, an active feedback module 656. Electrical supply 652 supplies an electrical potential to conductive portion 115 and a reference potential to reference electrode 160, as discussed in connection with FIG. 1. Electrical supply 652 further supplies a counter potential to counter electrode 670 through connector 658. Electrical current meter 654 measures the electrical current flowing between conductive portion 115 and counter electrode 670. Not all connections within electrical system 650 are illustrated in FIG. 6. Optional active feedback module 656 is communicatively coupled with electrical current meter 654 and at least one of electrical supply 652 and controller 145. Optional active feedback module 656 may adjust one or both of (a) the electrical potential applied to conductive portion 115 by electrical supply 652 and (b) properties of the megasonic field, based on the electrical current measured by electrical current meter 654. In certain embodiments (not illustrated in FIG. 6), one or both of a reference electrode 160 and counter electrode 670 are conductive portions of surface 112, different from conductive portion 115.

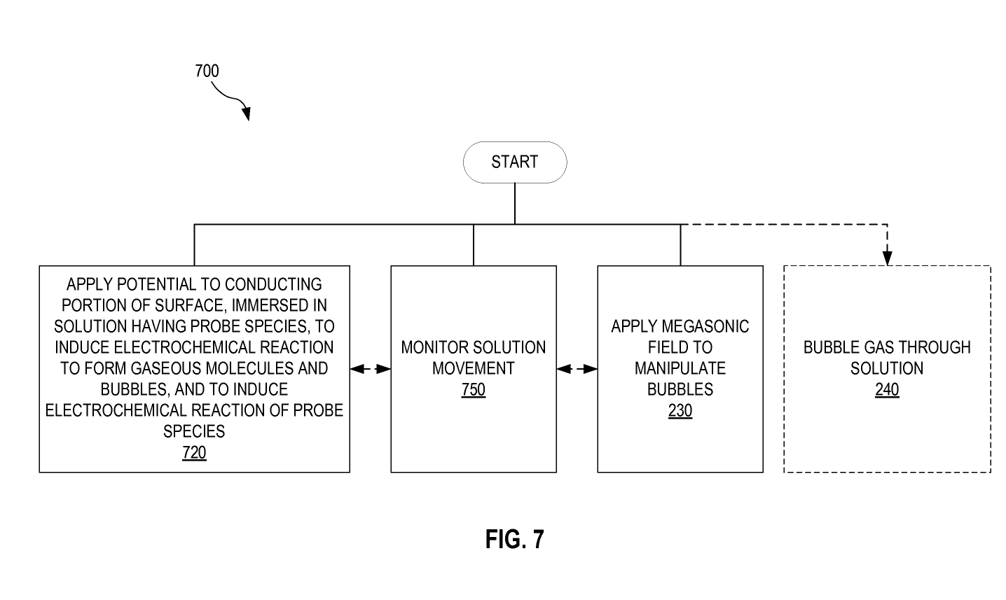

FIG. 7 illustrates one exemplary method 700 for performing electrochemically-assisted megasonic cleaning of the surface of an object that includes a conductive surface portion. Method 700 is an extension of method 200 further including monitoring solution movement and, optionally, adjusting system parameters based thereupon. Method 700 is used, for example, to actively monitor electrochemically-assisted megasonic cleaning and adjust process parameters during the cleaning process to achieve optimal cleaning conditions. Method 700 may further be used to generate optimized process parameters for use in subsequent cleaning processes. Method 700 executes steps 720, 750, 230, and, optionally, 240, in parallel. Method 700 is performed, for example, by system 600 of FIG. 6.

Step 720 is identical to step 220 of method 200 (FIG. 2) except that the electrical potential applied to the conducting portion of the surface is such that it induces an electrochemical reaction involving a probe species, in addition to the electrochemical reaction that leads to formation of gaseous molecules. The probe species is a species in the solution, which is capable of undergoing an electrochemical reaction when in contact with an electrode having a suitable electrical potential relative to a reference electrical potential of the solution. For example, the solution may be an aqueous solution that includes the probe species ferricyanide or a ferricyanide compound. Ferricyanide is capable of undergoing reduction when in contact with an electrode at a sufficiently negative electrical potential. The probe species induces a measurable electrical current, relating to solution movement, between a conductive portion of the surface, e.g., conductive portion 115 (FIGS. 1 and 6), and a counter electrode, e.g., counter electrode 670 (FIG. 6).

Step 230 is discussed in connection with method 200 (FIG. 2).

In step 750, the solution movement is monitored. As bubbles oscillate in size, the probe species concentrates at the conductive portion of the surface. The probe species concentration may be due to advection-based diffusion of the probe species, microstreaming of solution containing the probe species, or a combination thereof. The oscillation in probe species concentration at the conductive surface portion results in an electrical current between the conductive portion of the surface and a counter electrode in contact with the solution. For example, electrical current meter 654 (FIG. 6) measures the electrical current to the conductive surface by measuring electrical current running between conductive portion 115 (FIGS. 1 and 6) and counter electrode 670 (FIG. 6).

In an embodiment, method 700 adjusts properties of one or both of steps 220 and 230 based on the solution movement measured in step 750. Megasonic field properties adjusted may include but are not limited to frequency, transducer power, duty cycle, and an on-time. Optionally, method 750 includes active feedback between steps 750 and 220, and/or between steps 750 and 230, such that properties of steps 220 and/or 230 are continuously or regularly adjusted to optimize the cleaning process. For example, active feedback module 656 (FIG. 6) receives data from electrical current meter 654 (FIG. 6) indicative of solution movement. Based on this data, active feedback module 656 (FIG. 6) changes a parameter of electrical supply 652 (FIG. 6) and/or one or more parameters of controller 145, to optimize movement of the solution. In certain embodiments, method 700 further includes step 240 discussed in connection with FIG. 2.

Optional step 240 is discussed in connection with FIG. 2. Optional step 240 may be initiated prior to steps 720, 750, and 230, such that the solution is properly conditioned prior to performing steps 720, 750, and 230.

### Example I

### Electrochemically-Assisted Megasonic Cleaning of Tantalum Surfaces

This example demonstrates electrochemically-assisted megasonic cleaning of a Tantalum (TA) surface according to an embodiment of method 200 (FIG. 2) using an embodiment of system 100 (FIG. 1). The example includes an electrochemical experiment, wherein an embodiment of system 600 (FIG. 6) is utilized according to an embodiment of method 700 (FIG. 7) to investigate and optimize the electrical potential applied to the conductive surface.

Materials and Methods.

Deionized (DI) water of 18 MΩ/cm resistivity was used for all electrochemical and cleaning experiments, i.e., in this example, solution 120 (FIGS. 1 and 2). Semiconductor grade isopropyl alcohol (IPA) was purchased from Sigma Aldrich Inc. VLSI grade ammonium hydroxide (NH4OH), hydrogen peroxide (H2O2) and hydrofluoric acid (HF) were purchased from Honeywell Inc. Silica microspheres (10%, wt.) of mean size 300 nm were obtained from Polysciences Inc. Tantalum films (400 nm), an embodiment of conductive portion 115 (FIGS. 1 and 6), deposited onto 2″ p-type doped blanket silicon wafers (5-10 mΩ/cm) were procured from Addison Engineering Inc. Platinum foil (99.999%) used as counter electrode 670 (FIG. 6) was purchased from Alfa-Aesar. Standard Ag/AgCl (sat KCl) electrode was used as reference electrode 160 (FIGS. 1 and 6). Ultra high purity argon (99.999%) gas was used to deoxygenate the DI water/KCl solutions used in experiments using an embodiment of bubbling system 170 (FIGS. 1 and 6).

Pre-cleaning of the Ta films was performed using isopropyl alcohol (IPA) for 1 min, followed by SC-1 (1:1:50 of H2O2:NH4OH:H2O) and HF (1:100) treatments for about 5 minutes and 30 seconds, respectively. Each pre-cleaning step was followed by a thorough rinsing with DI water and spin drying for 1 minute at a speed of 1000 rpm. For the electrochemical experiments, the Ta samples were diced into 1×1 cm size. The electrochemical setup consisted of a glass vessel (˜250 ml) sealed with a rubber stopper, an embodiment of container 130 (FIGS. 1 and 6), with provision for inserting connection 152 (FIGS. 1 and 6), reference electrode 160 (FIGS. 1 and 6), and counter electrode 670 (FIG. 6). The argon (Ar) bubbling was performed for 30 min to remove dissolved oxygen and a blanket of the gas was maintained above the liquid surface just prior to the experiment to prevent diffusion of the oxygen from the atmosphere back into the solution. This is an embodiment of step 240 (FIGS. 2 and 7). Electrochemical experiments were performed using a potentiostat Gamry Interface 1000, and embodiment of electrical system 650. The current sensitivity of the potentiostat is about 3.3 fA. Cathodic polarization experiments were carried out at a scan rate of 1 millivolt/second under cathodic polarization conditions.

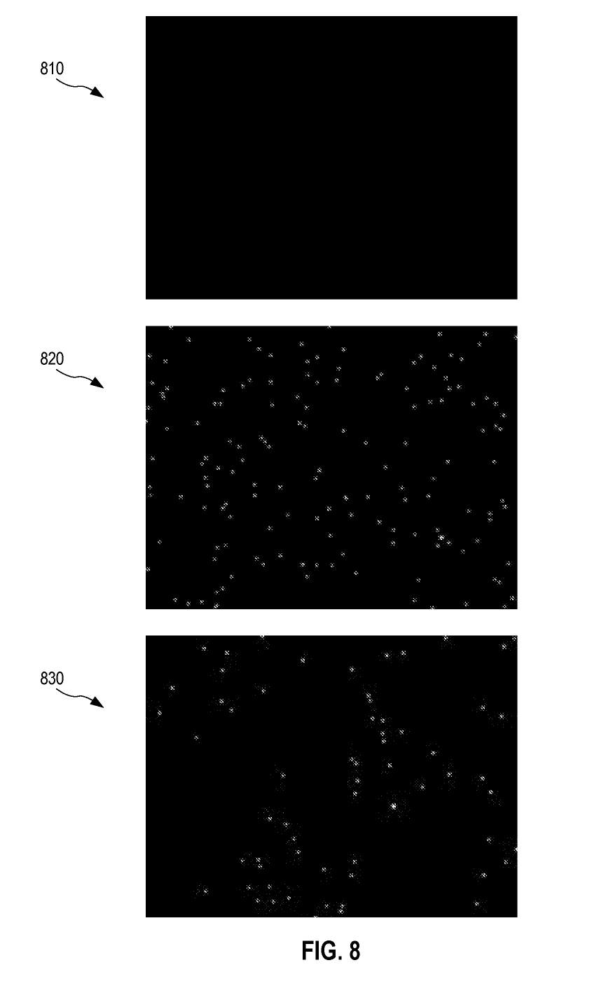

For cleaning experiments, the Ta surface was contaminated by dispensing 1 ml of the sonicated 300 nm silica microsphere (0.001%, wt.) dispersion of pH 5.8 onto the rotating sample. Zetasizer nano ZS (Malvern Instruments) was used to determine the mean particle size and zeta potential of SiO2 particles in DI water. The measured particle size and zeta potential were about 293±25 nm and −51.2 mV, respectively. The blanket Ta wafer was viewed and imaged under the microscope (Leica DM 4000M) before and after contamination and after cleaning. The particles were counted using ImageJ software. After counting the number of particles deposited, the samples are then aged for about 24 hours. Cleaning studies were then conducted the following day by varying the different process parameters for a constant cleaning time of 60 seconds. FIG. 8 shows an example of microscope images of Ta surface at 500× magnification before contamination (image 810), after contamination (image 820) and after cleaning under specific condition (image 830). The number of particles as counted using ImageJ was zero, 150 and 65, respectively on the measured area of 0.02 mm².

The setup for cleaning experiments is an embodiment of system 100 (FIG. 1). In this example, container 130 (FIG. 1) includes a cylindrical polypropylene bowl (Megbowl®, Prosys Inc.) with a circular megasonic transducer, an embodiment of megasonic transducer 140 (FIG. 1), affixed at the bottom and configured to generate a megasonic field with a frequency of 0.93 MHz. The transducer has a surface area of approximately 22.2 cm². About 500 ml of aqueous solution, an embodiment of solution 120 (FIG. 1) was used for each experiment. For all megasonic experiments, the power density, duty cycle and on-time were fixed at 0.5 W/cm2, 10% and 5 ms, respectively. The electrical potential was applied by means of Agilent 33250A wave generator, an embodiment of electrical supply 150 (FIG. 1).

Results and Discussion.

Cathodic polarization experiments (i.e., electrochemical experiments) were performed to identify the range of electrical potential applied to the Ta surface, where water reduction occurs to form hydrogen gas. Based on these measurements, a suitable electrical potential condition was identified and used later in electrochemically-assisted megasonic cleaning experiments to determine its effect on removal of particles from Ta surface under two different electrical potentials.

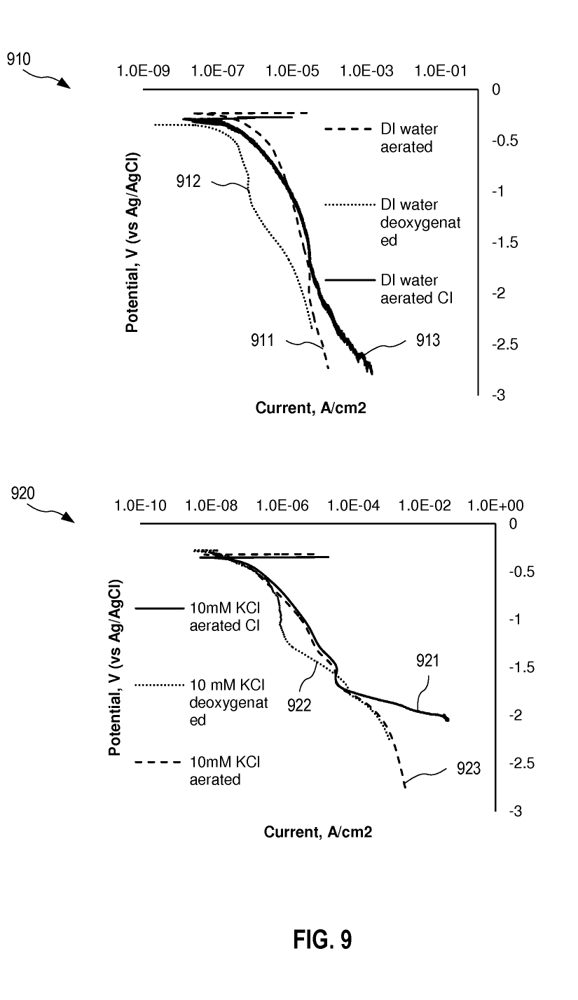

FIG. 9 shows the cathodic polarization of Ta film in deoxygenated DI water (curve 912 of plot 910) and 10 mM KCl solution (curve 922 of plot 920). From FIG. 9 it can be seen that the open circuit electrical potential of Ta in either of the solutions was about −0.35V (vs. Ag/AgCl (sat KCl)). As the electrical potential is scanned in the negative direction, the electrical current initially increases slowly in the electrical potential range of about −0.5 to −1 V (vs. Ag/AgCl). After about −1 V (vs. Ag/AgCl) the electrical current increases rapidly until about −2 V (vs. Ag/AgCl) possibly indicating the reduction of water according to the reaction 2H₂O+2e⁻→H₂+2 OH⁻. Also, there is a distinctive effect of deoxygenating the solution, wherein a steady electrical current could be observed between −0.5 and −1V in both curve 912 of plot 910 and curve 922 of plot 920, which was absent in the cases of aerated solutions (curves 911 and 923) and aerated solutions with current interference (CI) (curves 913 and 921). This steady state electrical current may be attributed to a diffusion control regime that could possibly arise owing to the fact that there is no dissolved oxygen present in the solution to undergo reduction. It may also be seen that the slope of the curve for Ta films in 10 mM KCl solution (plot 920) is greater than that for pure DI water (plot 910). This is indicative of the fact that there is likely a greater generation of H₂ owing to the greater conductivity of the KCl solution. Therefore, from the cathodic polarization plot, the favorable conditions for performing particle removal studies were considered to be in the electrical potential range of −1 to −2 V (vs. Ag/AgCl).

The SiO₂ contaminated Ta wafers were subjected to a series of cleaning experiments, wherein the effect of various parameters such as dissolved gases (Ar and air), power density (0.5 W/cm²) and applied electrical potential (−1.5 V and −2 V, vs. Ag/AgCl) were investigated and the results obtained are discussed below.

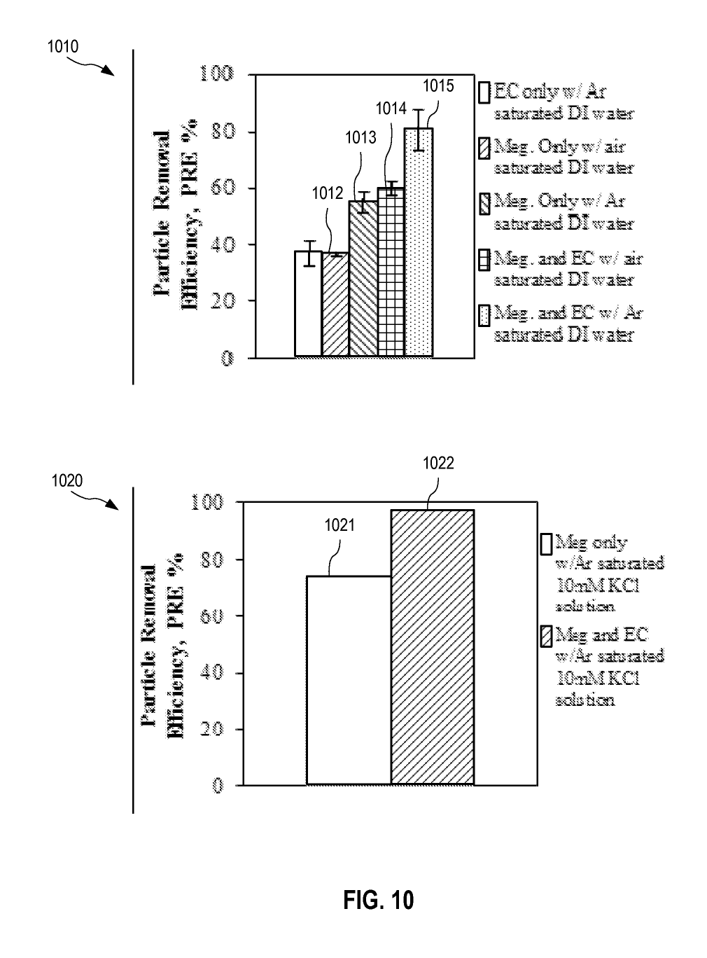

FIG. 10 shows plots 1010 and 1020 of particle removal efficiency under different cleaning conditions. The power density was fixed at a low value of 0.5 W/cm² and the applied electrical potential was −1.5 V (vs. Ag/AgCl reference). The reason for having the duty cycle of only 10% with an on-time of 5 ms was twofold. The first reason is based on experiments discussed in Example II, where it is shown that under these conditions of applied negative electrical potential and duty cycle, hydrogen bubbles that are formed close to the conductive surface grow to a resonant size of 7 μm and generate significant microstreaming forces. Secondly, low duty cycle of 10% for on-time of 5 ms significantly reduces the occurrence of transient cavitation that is known to cause damage to features during megasonic cleaning. From plot 1010, it can be seen that for Ta wafers in the presence of a megasonic field, the particle removal efficiency in the absence (bar 1013) and presence (bar 1015) of an applied electrical potential was about 55% and 75%, respectively in Ar saturated DI water. This increase in particle removal efficiency is possibly indicative of the effect of microstreaming due to in-situ generation of hydrogen during water reduction. The same effect was observed in the case of DI water saturated with air (bars 1012 and 1014).

It may also be noticed from plot 1010 that the particle removal efficiency in Ar saturated water was higher by 25% than that in air saturated water under the applied electrical potential condition. When the experiments were carried out in megasonic irradiated 10 mM KCl solutions saturated with Ar, the particle removal efficiencies in the absence (bar 1021 of plot 1020) and presence (bar 1022 of plot 1020) of applied electrical potential of −1.5 V (vs. Ag/AgCl) were about 75 and 95%, respectively. The enhanced particle removal is likely due to the electro-acoustic effect that originates in the presence of an electrolyte and higher generation of hydrogen gas (compared to that in DI water) when the electrical potential (−1.5 V) is applied.

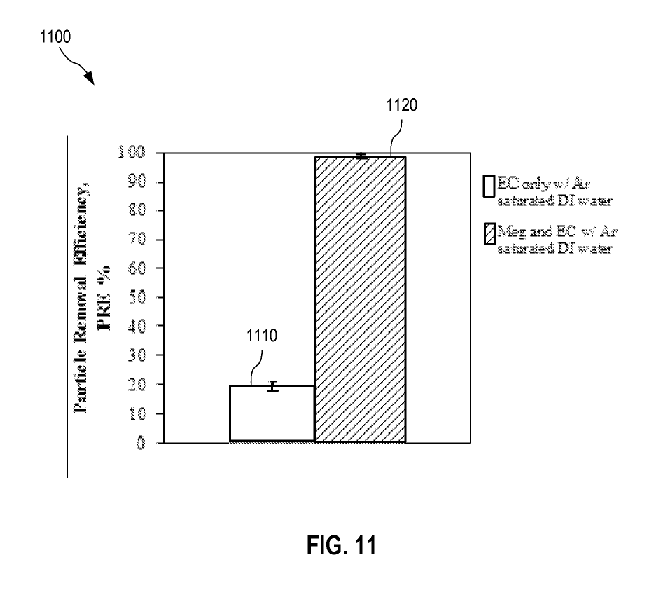

FIG. 11 shows a comparison plot 1100 of particle removal efficiencies in Ar saturated DI water when a more negative electrical potential of −2 V (vs. Ag/AgCl) was applied in both the absence (bar 1110) and presence (bar 1120) of a megasonic field (0.5 W/cm², 10% duty cycle). Particle removal efficiency as high as 98% was achieved in the presence of applied electrical potential of −2 V (vs. Ag/AgCl) and low energy megasonic field. This clearly demonstrates the usefulness of the presently disclosed systems and methods for electrochemically-assisted megasonic cleaning, applied to patterned wafers.

### Example II

### Electrochemical Investigations of Stable Bubble Oscillation Generated During Reduction of Water

This example utilizes an embodiment of system 600 of FIG. 6 together with an embodiment of method 700 of FIG. 7. The effects of parameters of method 700 (FIG. 7) are investigated. The example demonstrates the formation and growth of stable bubbles, generated during electrochemically induced reduction of water, and stable oscillation of the bubbles in response to an applied megasonic field.

Materials and Methods.

High purity (99.9%) chemicals (potassium ferricyanide (K₃Fe(CN)₆) and potassium chloride (KCl)) were purchased from Sigma Aldrich. Platinum wires (99%) were procured from Goodfellow. One platinum wire functions as the conductive surface to be cleaned, i.e., conductive portion 115 (FIGS. 1 and 6). Another platinum wire functions as reference electrode 160 (FIGS. 1 and 6), and yet another platinum wire functions as counter electrode 670 (FIG. 6). The megasonic power density, applied by an embodiment of megasonic transducer 140 (FIGS. 1 and 6), was fixed at 2 W/cm2 while percent duty cycle was varied between 10% and 100% with a 5 ms on-time. In this example, solution 120 (FIGS. 1 and 2) was an aqueous solution containing 0.1 M KCl, either with or without 50 mM (K₃Fe(CN)₆). Ferricyanide is an embodiment of the probe species used in method 700 of FIG. 7. These solutions were prepared using high purity DI water of resistivity 18 MΩ/cm. The solutions were saturated with Ar gas by bubbling for 30 min, using an embodiment of bubbling system 170 (FIGS. 1 and 6), and keeping an Ar blanket over the liquid surface during the measurements. The removal of dissolved O₂ was confirmed by measuring the oxygen level using an oxygen sensor (Rosemount 152 Analytical model 499A DO).

Chronoamperometry experiments were conducted using a function generator Agilent 33250A with a custom built potentiostat equipped with positive feedback ohmic drop compensation, an embodiment of electrical system 650 (FIG. 6). Measurements were performed with and without application of electrical potential at −2 V (versus Platinum (Pt) reference or −1.4 V versus standard hydrogen electrode) to the platinum wire functioning as conducive portion 115 (FIGS. 1 and 6), in the absence and presence of megasonic field at a frequency of approximately 1 MHz. The data were acquired at a high sampling rate of 8 MHz using an oscilloscope (NI USB-5133). NI LabVIEW 9.0 and DIAdem™ 2010 were used for data acquisition and graphical processing, respectively.

Results and Discussion.

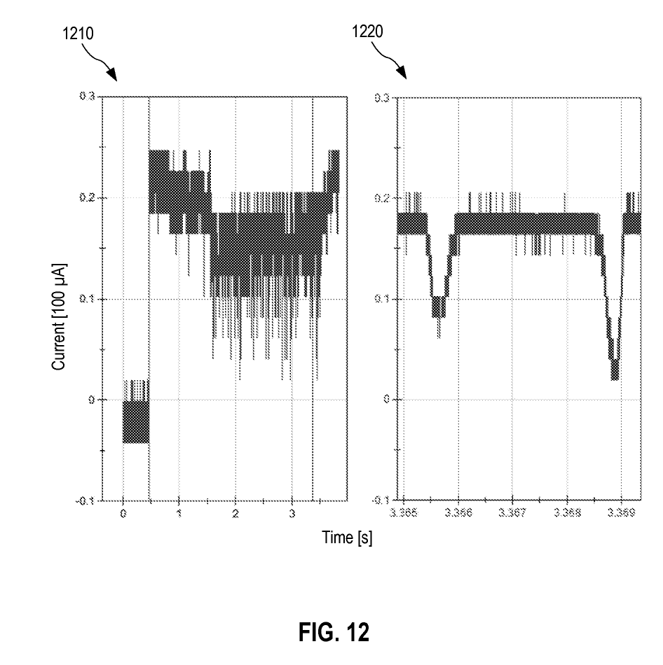

A first set of experiments was carried out using Ar saturated aqueous solutions containing 0.1 M potassium chloride and no ferricyanide. The results are shown in FIG. 12, plot 1210, where the y-axis represents electrical current and x-axis depicts time. The first 0.5 s of data was collected without any applied electrical potential and megasonic energy. During this time, no electrical current was measured. After 0.5 s, an electrical potential of −2.0 V (versus Pt) was applied to the working electrode (25 μm) at which time the electrical current shoots up to a steady or limiting value of 20-25 μA. Since the applied electrical potential is far more negative than the standard reduction potential of water (−0.83 V), the limiting electrical current may be attributed to reduction of water to hydrogen gas and hydroxyl ion. Upon application of megasonic field at 100% duty cycle (DC) after 1 s of applied electrical potential, the limiting electrical current shows ‘valleys’ superimposed on it.

FIG. 12, plot 1220, displays examples of these electrical current ‘valleys’ with expanded time scale. The fall or dip times of ‘valleys’ range from 8 μs to 0.3 ms with majority of them occurring between 0.1 ms and 0.3 ms time scale while the rise was found to vary from 0.1 ms to 0.3 ms. We interpret the fall in electrical current as possibly due to the formation and growth of hydrogen bubbles in the close vicinity of the electrode surface. Due to continuous generation of hydrogen gas at the electrode surface, there is enough gas available to form and grow oscillating bubbles by rectified diffusion. As the bubbles grow, they mask the electrode surface, which causes the electrical current to fall. After some time, bubbles have grown to sizes that exceed the acoustic boundary layer and are swept away from the electrode surface due to the liquid flow from acoustic streaming and the electrical current recovers to the limiting value. After the megasonic field is switched off at about 3.5 s, the electrical current ‘valleys’ no longer appear on the limiting current.

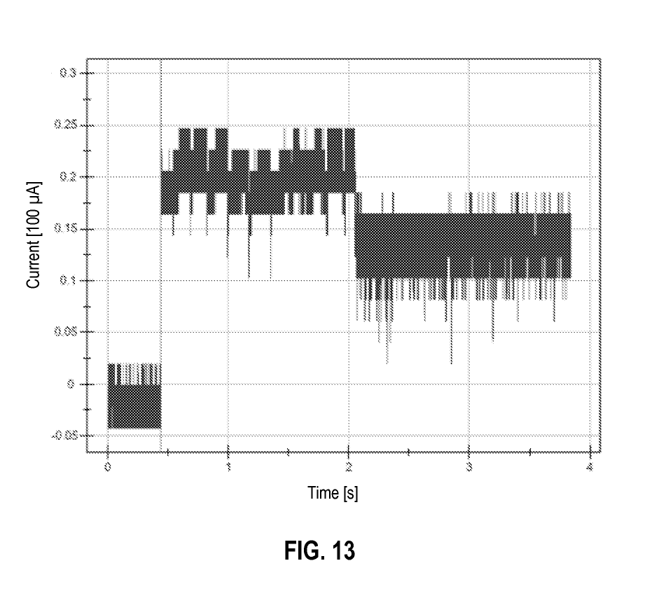

When the megasonic field is applied at 10% duty cycle, the electrical current-time data, illustrated in FIG. 13, shows mostly noise in electrical current and hardly any electrical current ‘valleys’. At 10% duty cycle, the screening of the electrode due to hydrogen bubbles may not be efficient enough due to the formation of (a) a smaller number of bubbles close to the electrode surface and (b) not enough time for the bubbles to grow beyond the resonating size (approximately 3.8 μm radius at about 1 MHz megasonic frequency) by rectified diffusion. In this case, since the area blocked by few small bubbles is much smaller than the electrode area, it does not lead to any measureable drop in electrical current.

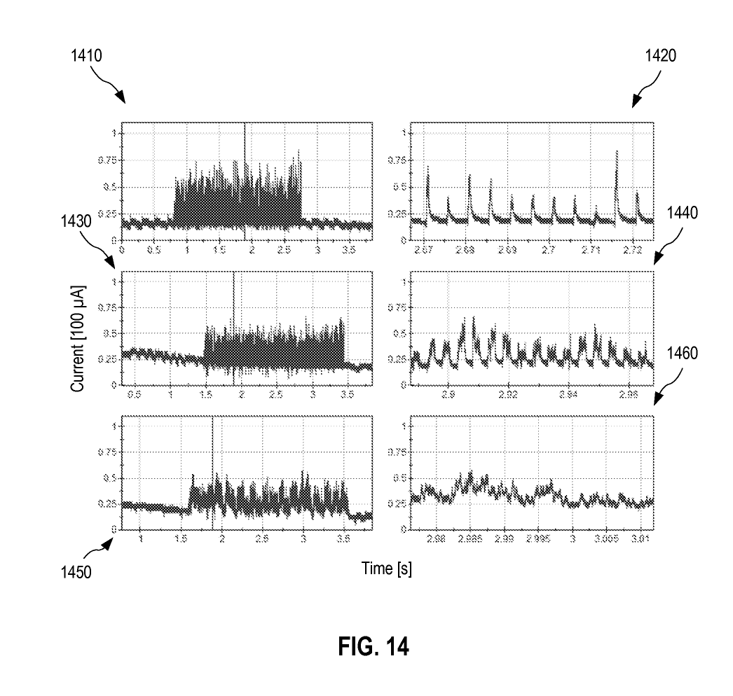

FIG. 14 shows the effect of addition of potassium ferricyanide on the measured electrical current at different percent duty cycle (for fixed on-time of 5 ms) for Ar saturated aqueous KCl solution irradiated with megasonic field. In all cases, the working electrode was biased at −2.0 V (versus Pt reference) throughout the experiment. Firstly, the electrical current is measured in the absence of megasonic field for the first 1.6 s, then the megasonic field is turned on for 2 s followed by about 0.5-1 s of electrical current measurement again in the absence of megasonic field. The limiting electrical current in the absence of megasonic field was approximately constant at 20-25 μA, as in the previous case with no ferricyanide, indicating that the electrical current due to ferricyanide reduction is negligible compared to that due to water reduction.

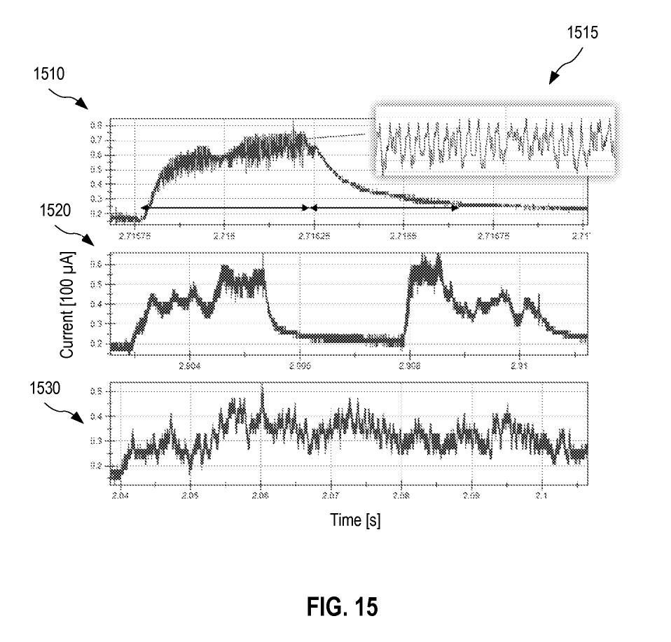

At 10% duty cycle, corresponding to the transducer on- and off-times of 0.5 and 4.5 ms respectively, the results shown in plots 1410 and 1420 indicate electrical current ‘peaks’ riding on the limiting electrical current. Plot 1420 shows a portion of the data from plot 1410 at an expanded time scale. These electrical current ‘peaks’ exhibit a rise time of 0.5 ms (same as the transducer on time) and fall time of less than 1 ms. The maximum current reached by peaks is about 85 μA with many peaks crossing 70 μA. FIG. 15, plot 1510 with insert 1515, shows an example of such an electrical current ‘peak’ with expanded time scale. After the initial rise of electrical current (for less than 0.1 ms) oscillations with large amplitude (about 20-30 μA) occur with an oscillating frequency corresponding to that of the megasonic field (about 1 MHz). This observation is interpreted as follows: (a) a small number of bubbles are nucleated and start oscillating with the acoustic field when the megasonic field is turned on, (b) bubbles grow to resonant size by diffusion of hydrogen gas from the surrounding liquid due to continuous water reduction and the oscillation amplitude of the bubbles increases, (c) bubbles attain a resonant size (about 3.8 μm radius at about 1 MHz sound frequency) after about 0.3 ms and exhibit high amplitude oscillations. The increase in electrical current upon application of megasonic field may be attributed to enrichment of ferricyanide by advection followed by its subsequent diffusion every time the bubbles shrink during their oscillation. However, when the bubble oscillations are large, the current is significantly affected not only by advection-based diffusion of ferricyanide but also by transport of ferricyanide towards and away from the electrode surface due to microstreaming (reflected in the form of oscillating current). After the megasonic field is stopped, the electrical current fall back to the limiting value.

Using the steady electrical current value of 20 μA, the time taken by a single bubble to reach the resonant size may be approximately computed assuming that diffusion of hydrogen gas into the bubble is fast enough and rate of hydrogen generation is the limiting step. Since two electrons are required to produce one hydrogen molecule during reduction of water, a current of 20 μA would correspond to 1.25×10¹⁴ electrons per second or 6.2×10¹³ hydrogen molecules per second. At a temperature of 25° C. and a pressure of 1 atmosphere, a bubble of radius 3.8 μm (or volume 2.3×10⁻¹⁶ m³) would have 5.7×10⁹ molecules assuming ideal gas behavior. Therefore, the bubble reaches the resonant size in ˜0.1 ms, which is on the same order of magnitude but slightly smaller than the rise time of ‘peaks’ possibly due to the assumption that all hydrogen produced goes into the formation of a single bubble. Once the bubble reaches a resonant size, it is likely to experience the streaming flow, which moves it away from the electrode. The acoustic boundary layer at 1 MHz sound frequency in DI water is about 0.5 μm calculated using δ=(ν/ω)^{0.5}, where ν is the kinematic viscosity of water and ω is the angular acoustic frequency. When the bubble is close to resonant size, a large portion of it is outside the acoustic boundary and therefore experiences the streaming flow. The fall time of bubble may be estimated as follows. The streaming velocities have been reported to be between 0 and 1.5 cm/s for sound frequencies of 0.5 to 4 MHz. Taking the maximum streaming velocity of 1.5 cm/s and assuming that the bubble has to move across the radius of the microelectrode (12.5 μm), the time taken by the bubble to completely pass the electrode would be ˜0.8 ms, which is close to that observed in this example. A shorter time might indicate that the cavity is lifted off the electrode plane before crossing its resonant radius.

At 50% duty cycle, illustrated in plots 1430 and 1440 of FIG. 14, a similar behavior is observed where electrical current ‘peaks’ are superimposed on the limiting current during the application of megasonic field. However, unlike the case of 10% duty cycle illustrated in plots 1410 and 1420, the electrical current does not increase steadily during the transducer on-time. Instead, the electrical current rises and falls a few times as may be seen from plot 1520 of FIG. 15, where examples of electrical current ‘peaks’ are shown with expanded time scale. Furthermore, the maximum electrical current measured for 50% duty cycle was 65 μA, which is lower than that measured for 10% duty cycle. This is most likely because the recovery time or the transducer off-time at 50% duty cycle (about 2.5 ms) is not sufficient to allow all the gaseous bubbles present in the solution to dissolve away during the transducer off-time. The residual bubbles that survive the transducer off-time interfere with the behavior of new bubbles that form and grow with the beginning of each megasonic cycle.

This is further evident from results of 100% duty cycle displayed in plots 1450 and 1460 of FIG. 14, as well as in plot 1530 of FIG. 15, which show that the maximum electrical current in this case is the lowest (about 55 μA). Additionally, the electrical current appears to vary significantly during the application of megasonic field possibly due to multiple bubbles interacting with each other at the same time. It is essential at this stage to point out an important difference in the results for the two cases of with and without ferricyanide. In the absence of ferricyanide, at 100% duty cycle, even though multiple tiny residual bubbles from previous cycle(s) may be present, the drop in electrical current is unlikely to be affected when the mechanism is primarily blocking of electrode by growing bubbles. Once the electrode is partially blocked, any interference from another bubble (that forms or passes between the growing bubble and the microelectrode) is undetected. However, in the presence of ferricyanide, when the rise in electrical current is due to diffusion, advection and micro streaming, the electrical current values are likely to be affected via interferences between multiple oscillating bubbles.

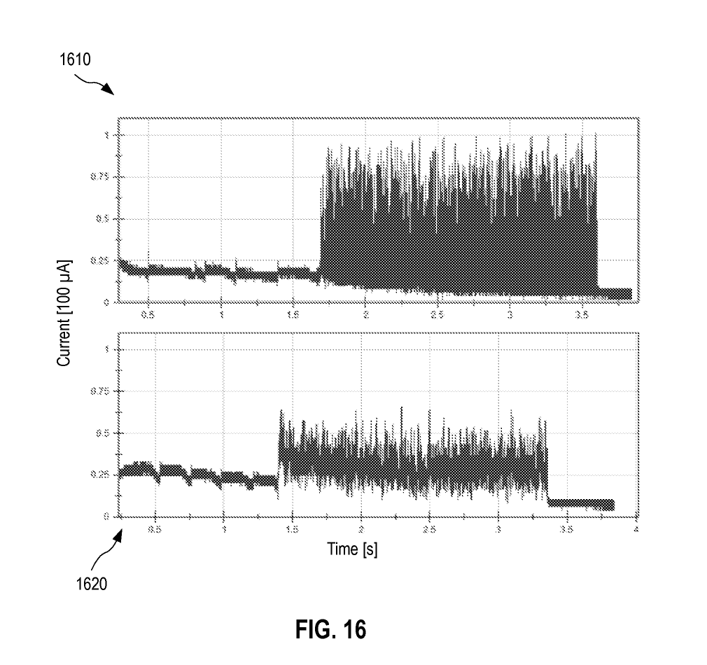

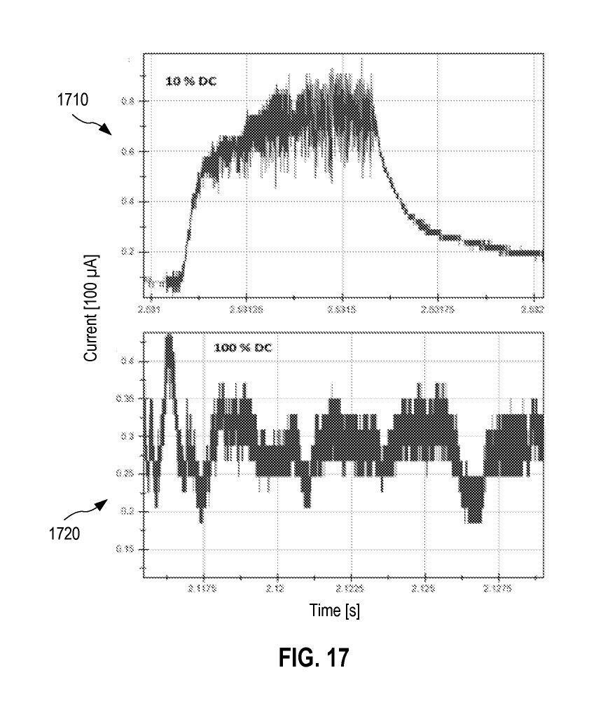

In order to determine if the reported bubble behavior (in the earlier sections) is predominantly that of a hydrogen bubble, experiments were performed in CO₂ saturated potassium chloride solutions containing potassium ferricyanide. The sequence of applying and removing the megasonic field was the same as that for the previous experiments. The results for 10% and 100% duty cycle are illustrated in plots 1610 and 1620, respectively, of FIG. 16. Plots 1710 and 1720 of FIG. 17 show portions of the data of respective plots 1610 and 1620 of FIG. 16 with expanded time scale. The limiting current measured in the absence of megasonic field was ˜20-25 μA. At 10% duty cycle, during megasonic exposure, current ‘peaks’ with rise time of 0.5 ms and fall time of less than 1 ms were observed whereas at 100% duty cycle, the current continuously varied with no particular trend. The maximum electrical current measured for 10% duty cycle (about 100 μA) was much higher than that measured for 100% duty cycle (about 65 μA). These electrical current values are somewhat higher than those measured in the case of Ar saturated solution indicating that the bubble behavior is partially influenced by the gas dissolved in the liquid. This suggests that the bubble may not be purely a hydrogen gas bubble but may also contain some other gas that was dissolved in the liquid. Additionally, since dissolved CO₂ is known to drastically reduce transient cavitation, presence of significant current ‘peaks’ in CO₂ saturated solution (during megasonic irradiation) for experiments conducted in this study, provides further evidence to the fact that the measured electrical current ‘peaks’ are due to stable oscillating bubbles and not collapsing cavities.

Changes may be made in the above systems and methods without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and device, which, as a matter of language, might be said to fall therebetween.

What is claimed is:

1. Electrochemically-assisted megasonic cleaning method comprising:
applying electrical potential to a conductive surface immersed in solution to form bubbles of gaseous molecules produced by electrochemical reaction; and
applying megasonic field to the solution to oscillate the bubbles and clean the conductive surface.

2. Method of claim 1, further comprising applying the megasonic field to the solution to oscillate the bubbles and clean non-conductive surfaces adjacent to the conductive surface.

3. Method of claim 1, wherein the step of applying megasonic field comprises applying megasonic field having frequency that cooperates with kinematic viscosity of the solution to define extent of an acoustic boundary layer of the conductive surface, and wherein the steps of applying electrical potential and megasonic field cooperate to form the bubbles within the acoustic boundary layer.

4. Method of claim 1, wherein applying the megasonic field induces oscillatory motion of the bubbles to produce movement of the solution within an acoustic boundary layer associated with the conductive surface.

5. Method of claim 1, wherein applying the megasonic field comprises applying the megasonic field with frequency and duty cycle such that at least some of the bubbles grow to resonant size during duty cycle on-time.

6. Method of claim 5, the solution having kinematic viscosity that, together with the frequency, defines an acoustic boundary layer extending a distance from the surface and into the solution, wherein applying the megasonic field comprises applying the megasonic field with frequency, duty cycle on-time, and power density at the acoustic boundary layer, such that only a minority fraction of the bubbles leave the acoustic boundary layer and the bubbles do not transform into damage causing transient bubbles.

7. Method of claim 5, wherein the step of applying megasonic field comprises applying the megasonic field with duty-cycle off-time such that at least a portion of the bubbles dissolve during the duty-cycle off-time.

8. Method of claim 5, wherein the frequency is such that the resonant size is smaller than minimum size of structural features in the surface.

9. Method of claim 9, the step of applying electrical potential to form bubbles of gaseous molecules by electrochemical reaction comprising applying electrical potential to form bubbles of dihydrogen by electrochemical reduction of water to dihydrogen and hydroxyl.

10. Method of claim 1, further comprising bubbling an inert gas through the solution to remove reactive gas from the solution.

11. Method of claim 1, further comprising adding a gas to the solution to reduce risk of bubble collapse.

12. Method of claim 1, further comprising degasing the solution to reduce risk of bubble collapse.

13. Method of claim 1, further comprising
adding a probe species to the solution;
measuring electrical current between the conductive surface and an electrode in contact with the solution;
determining at least one property of solution movement from the current; and
adjusting the megasonic field based on the properties of solution movement.

14. Method of claim 14, the step of adjusting the megasonic field based on the properties of solution movement comprising adjusting at least one of frequency, transducer power, duty cycle, and an on-time of the megasonic field to achieve resonant oscillation of the bubbles with the megasonic field.

15. Electrochemically-assisted megasonic cleaning system comprising:
electrical supply for applying electrical potential to a conductive surface immersed in solution to induce bubble formation in the solution and at the surface through an electrochemical reaction; and
transducer for applying a megasonic field to the solution to induce oscillation of the bubbles.

16. System of claim 15, the transducer having a duty cycle defined by an on-time and an off-time, the duty cycle being less than 100%.

17. System of claim 16, the transducer being configured, through the duty cycle, the on-time, transducer frequency, and transducer power, to induce resonant oscillation of at least a some of the bubbles during the on-time, and allow for dissolution of at least some of the bubbles during the off-time.

18. System of claim 15, further comprising an electrical current meter for measuring a current to the conductive surface, the current relating to solution movement.

19. System of claim 18, further comprising an active feedback module for adjusting at least one property of the transducer to optimize the solution movement.

20. System of claim 15, further comprising a gas flow module for bubbling an inert gas through the solution to displace reactive gas from the solution.
